(19) United States
(12) Patent Application Publication
(10) Pub. No.: US 2004/0215619 A1
(43) Pub. Date: Oct. 28, 2004

(54) System and method for integrating persistent and non-persistent storage in an integrated storage area

(75) Inventor: Kenneth F. Rabold, Bothell, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: BSQUARE Corporation

(21) Appl. No.: 10/424,368

(22) Filed: Apr. 24, 2003

(51) Int. Cl. G06F 7/00

(52) U.S. Cl. 707/10

(57) ABSTRACT

An integrated file system on a handheld computing device for managing files stored in persistent and non-persistent storage areas on the device is presented. The system includes a persistent storage area and a non-persistent storage area for storing files for the operating system. The system also includes an integration module coupled to the persistent and non-persistent storage areas, and further coupled to the operating system. The integration module presents the files stored in the persistent and non-persistent storage areas as an integrated storage area to the operating system. The integration module presents the files stored in the integrated storage area as files available for direct access by the operating system.

### FIELD OF THE INVENTION

The present invention relates to computer file systems, and in particular, to handheld computing device file systems for integrating persistent and non-persistent storage areas.

### BACKGROUND OF THE INVENTION

Handheld computing devices, commonly referred to as personal digital assistants (PDAs), have become extremely popular and are widely used. They are typically compact and portable having a small display area that doubles as a touch sensitive input device, typically involving a special pen or stylus. PDAs typically provide features such as calendaring, note taking, maintaining contact lists, calculator functions, and games, to name just a few.

Handheld computing devices do not typically have storage devices commonly found in desktop computers. In particular, handheld computing devices typically do not have hard disc drives, floppy drives, or optical media drives. Instead, handheld computing devices typically store data in memory.

Most handheld computing devices have two types of memory for storing information, persistent and non-persistent memory. Persistent memory generally refers to that type of memory, or storage area, that retains its stored information whether or not a power source is applied. Conversely, non-persistent memory retains stored information only so long as a power source is available and applied. Persistent memory is expensive and, typically, only a limited amount is available in a handheld computing device. The handheld computing device's operating system and installed programs occupy most of the available persistent memory.

Storing and retrieving data to and from persistent memory is substantially slower than the same operations on traditional, non-persistent memory. For this and other reasons, handheld computing devices do not execute or directly access information stored in persistent memory. In other words, persistent memory is not execute-in-place or access-in-place memory. Thus, the operating system or other programs and data must also be copied from persistent memory to non-persistent memory for execution. Copying the executable programs, including the operating system, from persistent to non-persistent memory usually takes place as the handheld computing device is powered on. Unfortunately, this process copies executable programs to non-persistent storage, thus reducing the amount of non-persistent memory that is available for user data storage. This results in a substantial inefficiency because a typical user will not exercise the entire operating system or all of the installed programs during a single operating session.

A user may be able to store data files or other information to persistent memory. The amount of persistent memory available depends on the amount of space necessary to store the operating system and installed programs as described above. Storing data files into persistent memory involves a specific operation to transfer the data from non-persistent to persistent memory. In many environments, this operation is performed as a file transfer function, such as while displaying the file system on the screen, explicitly transferring a file from a non-persistent area to a persistent area. Because persistent memory is not execute-in-place or access-in-place memory, in order to later access a file stored in persistent memory, that file must first be transferred back to non-persistent memory to complete an access.

In summary, the prior art lacks a file system that integrates files in both persistent and non-persistent memory, thereby establishing an integrated file system where files in both persistent and non-persistent storage are represented as available for direct access, and that automatically manages the transfer of information between persistent and non-persistent memory areas as needed.

### SUMMARY OF THE INVENTION

In accordance with the present invention, an integrated file system on a handheld computing device is presented for managing files stored in persistent and non-persistent storage areas for an operating system. The system includes an integration module coupled to the persistent and non-persistent storage areas, and further coupled to the operating system. The integration module presents the persistent and non-persistent storage areas as an integrated storage area to the operating system.

According to aspects of the present invention, the integration module presents files stored in the integrated storage area as files available for direct access by the operating system. More specifically, the integration module presents the integrated storage area to the operating system as a non-persistent storage area.

According to the present invention, a method for implementing file system requests on a handheld computing device by an integrated file system that presents files stored in persistent and non-persistent storage areas as files in an integrated storage area is presented. Upon receiving a file system request relating to a file stored in the integrated file system, the method determines whether the file is currently stored in an area of the integrated file system such that the file system request may be completed. If the file is not in an area such that the file system may be completed, the file is copied to an area in the integrated file system such that the file system request may be completed. Thereafter, the routine completes the file system request on the file.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating an exemplary handheld computing device suitable for operating the present invention;

FIG. 2 is a block diagram illustrating exemplary components of a handheld computing device suitable for operating the present invention;

FIG. 3A is a pictorial diagram illustrating an exemplary screen display of a handheld computing device that depicts files as stored separately in persistent and non-persistent storage areas, as found in the prior art;

FIG. 3B is a pictorial diagram illustrating an exemplary screen display of a handheld computing device that depicts files as stored in an integrated storage area in accordance with the present invention;

FIG. 4 is a block diagram illustrating an integrated file system that interfaces with an operating system and presenting files stored in persistent and non-persistent storage areas as files in an integrated storage area;

FIG. 5 is a state diagram illustrating transitions between file states in an integrated file system formed in accordance with the present invention;

FIG. 6 is a flow diagram illustrating a create file routine for creating files in an integrated file system formed in accordance with the present invention;

FIG. 7 is a flow diagram illustrating a change persistence attribute routine for changing the persistence attribute of a file in an integrated file system formed in accordance with the present invention;

FIG. 8 is a flow diagram illustrating a save file routine for saving files in an integrated file system formed in accordance with the present invention;

FIG. 9 is a flow diagram illustrating an open file routine for opening files on an integrated file system formed in accordance with the present invention; and

FIG. 10 is a flow diagram illustrating a close file routine for closing files stored in the integrated file system formed in accordance with the present invention.

### DETAILED DESCRIPTION

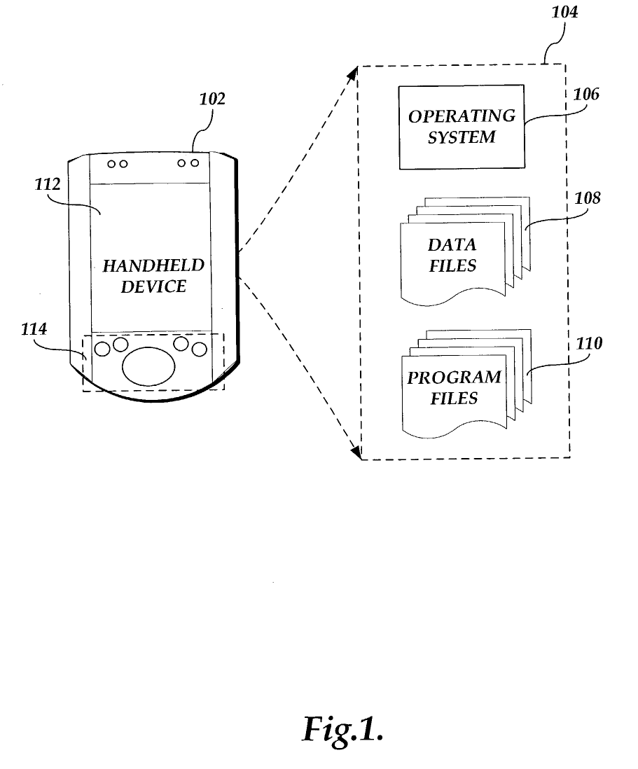

FIG. 1 is a pictorial diagram illustrating an exemplary handheld computing device 102 suitable for operating the present invention. Exemplary handheld computing devices include personal digital assistants (PDAs) from Palm, Compaq, and Sony, to name just a few. In addition to the traditional PDA systems, the present invention may be used in regard to other hybrid systems, such as those combining both wireless telephone services and PDA functionality. In general, the present invention applies to those handheld computing devices having a file system storing files in both persistent and non-persistent storage areas.

Information residing in the memory 104 of the handheld computing device 102 includes an operating system 106, data files 108, and installed program files (or executable files) 110. Exemplary operating systems include Palm OS from Palm, Inc., and Windows CE from Microsoft Corporation. However, these exemplary operating systems are illustrative only, and should not be construed as limiting upon the present invention. The data files 108 include those files generated by the user, directly or indirectly, in the course of operating the handheld device 102. The data files 108 may also include other files or data, such as program status files saved by a program file or operating system module, address information, etc. The installed programs 110 include those program files pre-installed by the handheld computing device vendor, and those installed by a user. In addition to the components described above, those skilled in the art will appreciate that other components may be stored in the memory 104 of the handheld computing device 102 that are not described. Thus, it should be understood that the described elements are for illustration purposes only, and should not be construed as limiting upon the present invention.

The handheld computing device 102 typically includes hardware buttons, such as buttons 114, for interacting with the user. The handheld computing device 102 also typically includes a display screen 112. The display screen 112 is typically touch or pressure sensitive and serves dual purposes: displaying information to the user, and accepting information from the user as an input device. Users typically interact with the handheld device 102 through the display screen 112 by touch or using a specialized pen or stylus (not shown). Handheld computing devices that are designed to interact with a stylus or pen are typically referred to as pen-based handheld computing devices. Other user interaction controls (not shown) may also be present, such as alphanumeric buttons, scrolling wheels, and the like. Accordingly, the described components should be viewed as illustrative only, and should not be viewed as limiting upon the present invention.

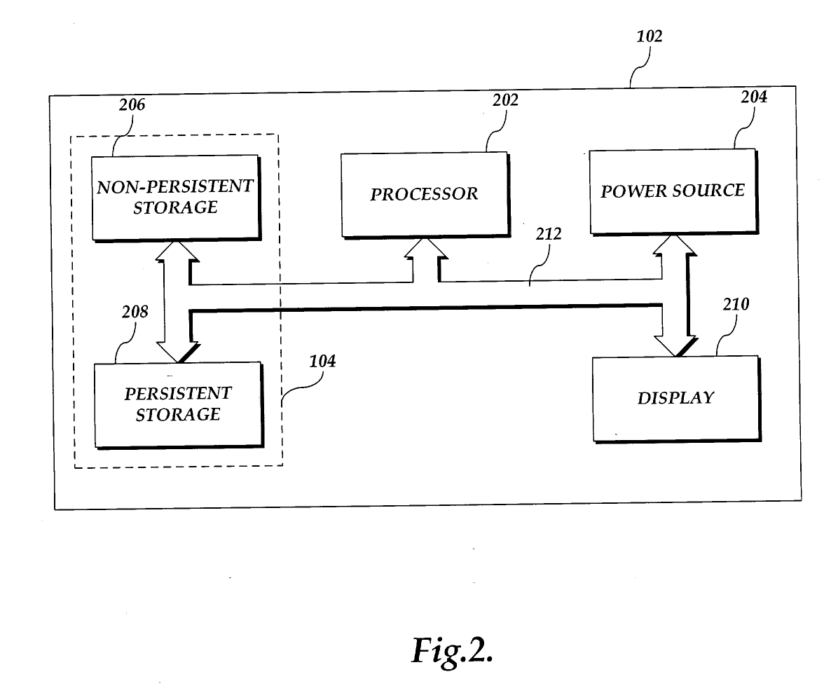

FIG. 2 is a block diagram illustrating exemplary components of a handheld computing device 102 suitable for operating the present invention. The handheld computing device 200 includes a processor 202 for processing computer executable instructions according to user input. Processors, such as processor 202, are well known in the art. The handheld computing device 200 also includes a power source 204. Handheld computing devices typically use batteries as a power source. The batteries may be integrated, rechargeable batteries, or commercially available batteries. For example, many PDAs currently operate on type AA or AAA disposable batteries. In addition, many handheld devices have an additional, secondary power source or battery (not shown). The secondary power source provides the handheld computing device 200 with a short, backup power source for preserving files within the handheld device after the primary power source 204 fails. Typically, when the power source 204 runs out of power, the handheld computing device 200 ceases to operate except for that function which is maintained by the optional secondary power source described above. Thus, when all power sources for the handheld computing device 200 run out of power, data stored in the non-persistent memory area is lost.

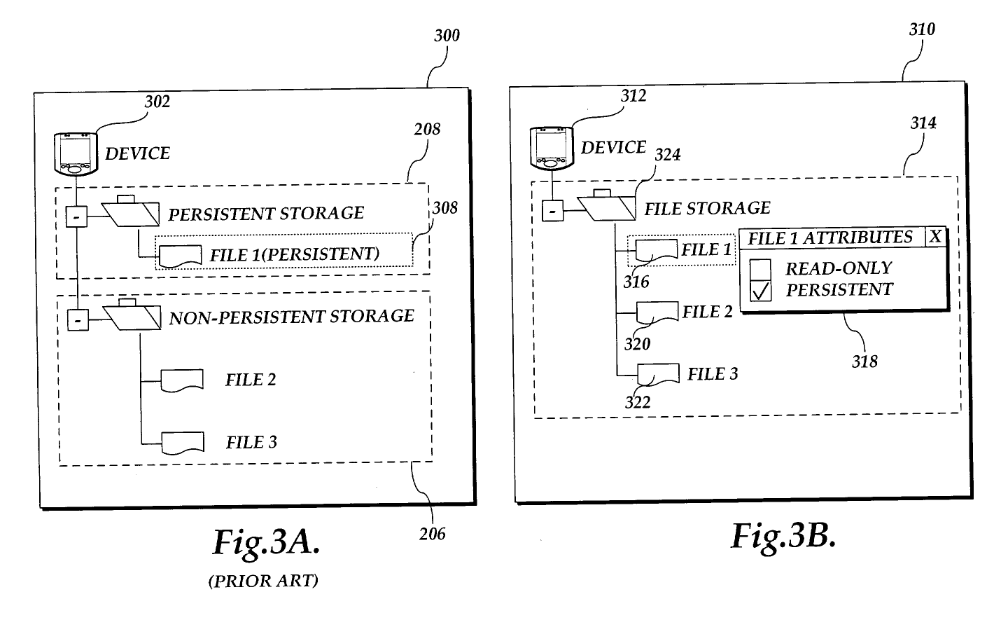

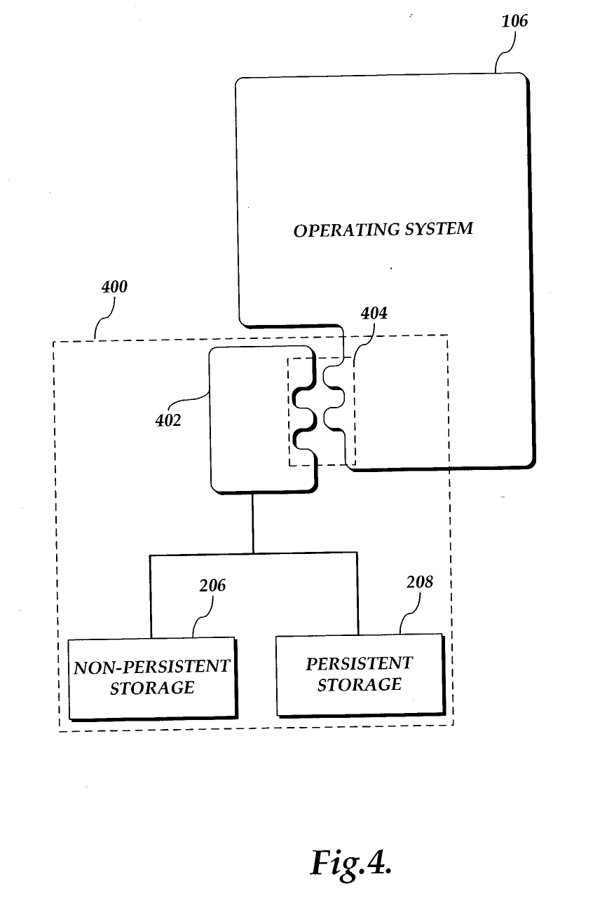

The handheld computing device 102 also includes a memory 104 having a non-persistent storage area 206 and a persistent storage area 208. As described above, the persistent storage area 208 contains data that is not lost when the power source 204, and optional secondary power source (not shown), lose their power. However, data within the persistent storage area 208 is typically not available for immediate, or direct execution or access. Information stored in the persistent storage area 208 must first be copied to the non-persistent storage area 206 in order to be accessed or executed. As will be described in further detail in regard to FIG. 3, copying data from the persistent storage area 208 to the non-persistent storage area 206, typically involves a specific operation.

The exemplary handheld device 102 also includes a display module 210. The display module 210 outputs information to the user via a display screen 112 (FIG. 1). As previously mentioned display screens, such as display screen 112, in handheld computing devices are typically pressure sensitive. Commonly these display screens are sensitive to a stylus (not shown) that is also provided with the exemplary handheld device. Thus, in addition to hardware buttons 114 as illustrated in FIG. 1, the user may also interact with the handheld computing device 102 through the display module 210, via the display screen 112, both in executing applications stored on the handheld device and in entering information into those programs.

The components of the handheld computing device 102 are interconnected via a system bus 212. While the present discussion identifies several exemplary components of a handheld computing device 102, those skilled in the art will recognize that other components may exist within a handheld computing device that are not described above. However, it is not necessary that all of these other components be shown in order to discuss an enabling embodiment for practicing the present invention. Thus, the elements described above are for illustration purposes only, and should not be construed as limiting upon the present invention.

FIG. 3A illustrates an exemplary screen display 300 of a handheld computing device illustrating an exemplary file system that depicts files as stored separately in persistent and non-persistent storage areas, storage areas 208 and 206 respectively, as found in the prior art. More specifically, files are depicted in the screen display 300 in a tree-like structure beginning with the root node 302, as indicated by the handheld computing device icon. Below the root node 302, are two separate partitions: storage area 208 representing persistent storage, and storage area 206 representing non-persistent storage. These separate partitions are indicative of the separation in memory between persistent and non-persistent storage areas as found in the prior art.

As is typical of the prior art, files may be copied between the persistent storage area 208 and the non-persistent storage area 206 using a specific file system command. As previously mentioned, files or data stored in the persistent storage area 208 are not access- or execute-in-place files. Thus, files must be first copied to the non-persistent storage area before accessing or executing the files. For example, “File 1” 308 is shown as stored in persistent storage. Because persistent storage is not access-in-place memory, the file must first be copied from the persistent storage area 208 to the non-persistent storage area 206 prior to its access by the operating system. This transfer is typically conducted using a transfer command specifically available to a file browsing program that displays files in a manner consistent with the screen display 300.

FIG. 3B illustrates a screen display 310 of a handheld computing device that depicts files as stored in an integrated storage area 314 in accordance with the present invention. Similar to FIG. 3A, files are displayed in a tree-like structure beginning with a root node 312. However, in contrast to the prior art file system described above in regard to FIG. 3A, files are displayed as stored in a single, integrated entity, as indicated by storage area 314. More specifically, files are depicted in FIG. 3A as stored in either the persistent storage area 208, such as “File 1” 308, or the non-persistent storage area 206, such as “File 2” and “File3.” In contrast, files are depicted in FIG. 3B as stored in an integrated storage area 314. For example, “File 1” 316, “File 2” 320 and “File 3” 322 are depicted as stored in a single partition of the integrated “File Storage” folder 324.

In accordance with yet further aspects of the present invention, a user may decide whether a file stored in the integrated storage area 314 is to be physically stored in persistent storage so that the file is not lost upon a power failure. For example, a user may select a persistence attribute associated with “File 1” 316 by selecting the appropriate box in a file attribute window 318. As can be seen, while a user is able to determine whether a particular file is stored in persistent or non-persistent memory, such as through file attribute window 318, the integrated file storage system of the present invention integrates and presents both persistent and non-persistent file storage areas as a single file storage system. In addition, the integrated file system of the present invention automatically transfers files in the persistent storage area 208 to the non-persistent storage area 206, and vice versa, as needed, thus relieving the user of this task.

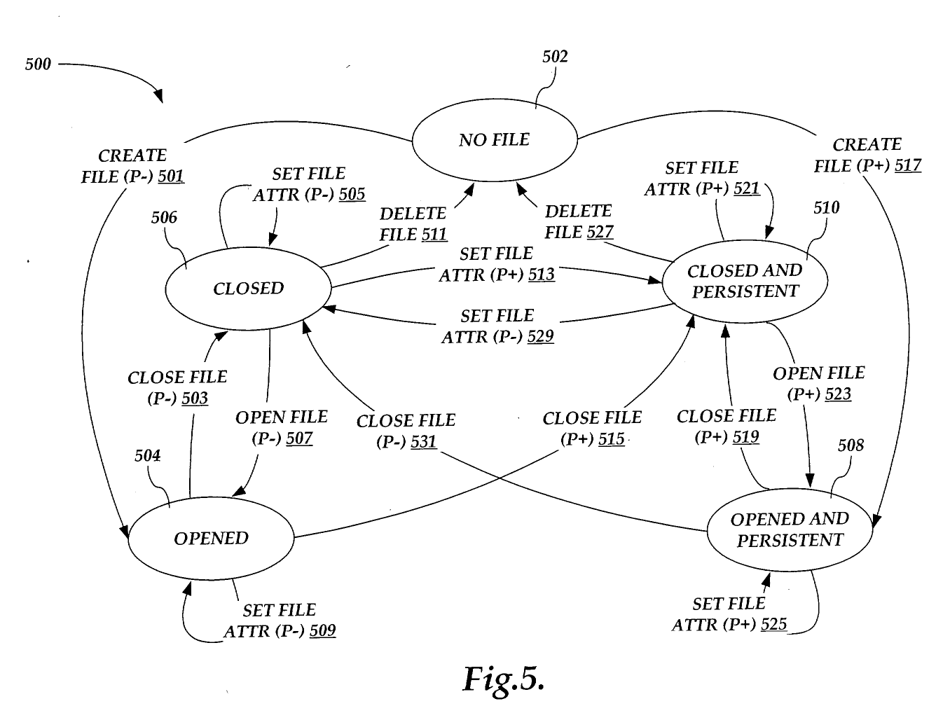

In order to present files stored in both persistent and non-persistent storage areas as files in an integrated storage area to the handheld computing device's operating system, the prior art file system that is typically provided with the handheld computing device must be replaced with an integrated file system formed in accordance with the present invention. FIG. 4 is a pictorial diagram illustrating an integrated file system 400 for interfacing with the operating system 106 of the handheld computing device 102 and presenting files stored in persistent and non-persistent storage areas as files in an integrated storage area. The integrated file system 400 includes an integration module 402 for interacting with the operating system 106. The integration module 402 manages the access to files stored in both the persistent and non-persistent storage areas, and presents them as files stored in a single integrated storage area. The integration module 402 interacts with the operating system 106 via a standard file system interface 404. Standard file system interfaces, such as the standard file system interface 404, are well known in the art.

The integration module 402 implements the standard methods and routines required by the file system interface 404. Because the integration module 402 implements these methods and routines, and also manages the access of files in the integrated file system 400, the operating system and other installed executable programs may access all files stored on the handheld computing device 102 without knowledge or concern as to whether the files are stored in the persistent storage area 208 or the non-persistent storage area 206.

As previously discussed, one aspect of persistent storage areas is that files stored in a persistent storage area cannot be accessed or executed in place, except when they are copied to the non-persistent storage area. Thus, in order to provide an integrated file system presenting files stored in both persistent and non-persistent storage areas as files stored in an integrated file system, the integration module 402 must ensure that files, or copies of the files, in the integrated file system are correctly located in the appropriate persistent or non-persistent storage areas when a request for access or execution is made. For example, upon receiving an access request for File A through its file system interface 404, the integration module 402 must determine if File A is stored in the non-persistent storage area 206, and if not, create a copy of File A in the non-persistent storage area upon which the access request may be completed. Upon receiving a subsequent close file request on File A, the integration module 402 closes the copy of File A in the non-persistent storage area 206 and modifications made to the copy of File A in the non-persistent storage area are copied back to File A in the persistent storage area 208. Optionally, the copy of File A in the non-persistent storage area may be deleted. Numerous other requests and conditions will cause the integration module 402 to copy or transfer a file between the persistent and non-persistent storage areas. Thus, it should be understood that the above-described example is for illustration purposes only, and should not be construed as limiting on the present invention.

The above-described example illustrates an implied, or implicit instruction to the integration module 402 to make a copy of File A in the non-persistent storage area 206. Specifically, attempting to directly access a file stored in the persistent storage area 208 implies that the integration module should create a copy of the file in the non-persistent storage area 206 and access the non-persistent copy. It follows that any modifications to File A, while it is opened, are made to the non-persistent copy. Additionally, because File A is a persistent file, as evidenced from its storage in the persistent storage area 208, upon closing the file, any modifications made to the non-persistent version are copied back to the persistent file in the persistent storage area 208.

In addition to implicit instructions, the implementation of the file system interface 404 is improved to permit explicit instructions to the integration module 402 as to the storage area of files in the integrated file system 400. For example, a program may be aware of the abilities of the integrated file system and provide the user with an option to specify the persistence of a file in the integrated file system 400. Thus, a user may instruct the program to open a file in the integrated file system 400, and provide an additional parameter for the open file request instructing the integrated file system to store the file in the persistent storage area 208. Alternatively, the user may instruct the program to close a file that is currently stored in the persistent storage area 208, such that the file will be stored only in the non-persistent storage area 206, i.e., the file is deleted from the persistent storage area. Each file system access, storage, or execute request may be augmented with an explicit instruction as to the persistence of a file. However, in order to ensure that existing programs need not be aware that the handheld computing device's 102 file system is an integrated file system 400, the additional parameter explicitly identifying a file's persistence is optional.

Either by implicit or explicit instructions, the integration module 402 manages the placement of files in the integrated file system 400, whether in the persistent storage area 208 or the non-persistent storage area 206, to ensure that files stored in the integrated file system are accessible without knowledge by the operating system of a file's persistence. More specifically, the integration module manages the storage of files in regard to five states: no file (i.e., deleted or not yet created) closed and non-persistent, opened and non-persistent, closed and persistent, and, opened and persistent.

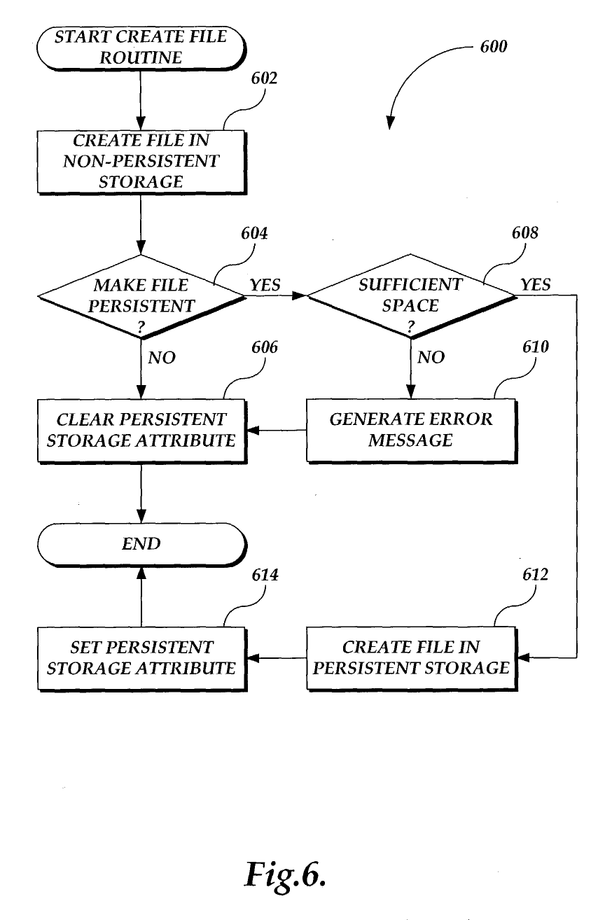

FIG. 5 illustrates a state diagram 500 representing transitions between file states managed by the integration module 402, in accordance with the present invention. Transitions between states occur according to file system requests including: create file, open file, close file, delete file, and set file attribute. The file states illustrated in FIG. 5 are logical states, and may not always completely reflect the storage of a file in the integrated file system 400. For example, in regard to a file that is stored in the persistent storage area 208, when that file is opened, because the persistent storage area is not access-in-place storage, a copy of the file is created in the non-persistent storage area 206. Thus, two copies of the file exist, though in regard to the file states of FIG. 5, only the file stored in the persistent storage area 208 exists. Therefore, the logical file states more accurately reflect how the files are viewed from outside of the integrated file system 400. For example, while multiple copies of the same file may exist in the integrated file system 400, programs external to the integrated file system should be unaware of these details.

As shown on FIG. 5, with two exceptions, each transition action, such as transition 501, displays a persistence parameter, either (P−) or (P+). The persistence parameters displayed in FIG. 5 are logical parameters for illustrating the transition from one state to another, and may or may not correspond to actual parameters passed to the integration module 402 in conjunction with a file system request. More specifically, a persistence parameter may be determined according to implicit or explicit instructions. An actual persistence parameter passed to the integration module 402 in conjunction with a file system request is an example of an explicit instruction. Each persistence parameter indicates the desired persistence of the file in conjunction with the file system request. A (P−) indicates that the persistence parameter is off, and that the file is to be made non-persistent, i.e., stored in the non-persistent storage area 206, in conjunction with the file system request. Alternatively, a (P+) indicates that persistence parameter is on, and that the file is to be made persistent, i.e., store in the persistent storage area 208.

The state diagram 500 illustrates five logical file states of the integration module 402 described above: state 502, where no file currently exists; state 504, where the file is open and stored in the non-persistent storage area 206; state 506, where the file is closed and stored in the non-persistent storage area; state 508, where the file is open and stored in the persistent storage area 208; and, state 510, where the file is closed and stored in the persistent storage area.

Beginning at state 502, transition action 501 “Create File”, with the persistence parameter off, transfers to state 504, where a file is created in the non-persistent storage area 206. A “Create File” request may be the product of a user attempting to create a new data file on the handheld computing device 102, or, alternatively, a program creating a temporary file. Additionally, the persistence parameter is off either by implicit or explicit instructions. According to aspects of the present invention, if the persistent parameter is not explicitly set in a “Create File” request, either to on or off, by default it's value is off. Thus, when a user creates a file, but fails to explicitly indicate if it should be located in the persistent storage area 208, by default it is stored in the non-persistent storage area 206. It should be understood that these examples are illustrative only, and should not be construed as limiting on the present invention. Additionally, other examples described below for causing transition actions to occur should also be viewed as illustrative, and not construed as limiting upon the present invention.

At state 504, transition action 503 “Close File”, with the persistence parameter off, causes a transfer to state 506, where the file is closed and stored in non-persistent storage. A “Close File” request corresponds to closing an open file. As with the “Open File” request above, the persistence parameter may be set, or determined, according to implicit or explicit instructions. For example, unless explicitly set, when closing a file that is stored in the non-persistent storage area 206, the persistence parameter is implicitly set to off. At state 506, transition action 505 “Set File Attribute”, with the persistence parameter off, has no net effect because the file in state 506 is already stored in the non-persistent storage area 206. Thus, transition action 505 “Set File Attribute” illustrates returning to state 506. A “Set File Attribute” request may be caused by explicitly setting the persistent attribute of a file, such as described in regard to file attribute window 318 (FIG. 3B). Other programs on the handheld computing device 102 may also provide for setting the persistence attribute.

At state 506, transition action 507 “Open File”, with the persistence parameter off, causes a transfer to state 504, where, as previously described, the file is opened and stored in non-persistent storage. An “Open File” request is a typical file system request to open that file. An “Open File” request will occur when an program is executed. Alternatively, an “Open File” request also occurs when a program, including the operating system, opens a file either for reading, writing, or both. At state 504, transition action 509 “Set File Attribute” with the persistence parameter off, has no net effect, because the file is already stored in the non-persistent storage area 206.

At state 506, transition action 511 “Delete File” causes a transfer to state 502 where the file is deleted from the system. As previously mentioned, a “Delete File” action does not require a persistence parameter as the specified file is to be removed from the integrated file system 400 entirely. At state 506, transition action 513 “Set File Attribute”, with the persistence attribute on, causes a transfer from state 506 to state 510, where the file remains closed, but is transferred to the persistent storage area 208. User actions causing a “Set File Attribute” transition action area described above, and are typically the result of an explicitly storage instruction. At state 504, transition action 515 “Close File”, with the persistence parameter on, causes a transfer to state 510, where the file is closed and stored in the persistent storage area 208. As described above, the persistence parameter associated with a Close File request may be determined either implicitly, i.e., the file is already stored in the persistent storage area 208 and no change is specified, or explicitly, i.e., the user explicitly sets a persistence attribute when closing the file. However, this “Close File” transition action 515 is most likely related to an explicit instruction to store the file in the non-persistent storage area 206. By default, a “Close File” action without an explicit instruction to save to a particular storage area would cause the file to be stored back to its current storage area. Thus, a “Close File” action with a persistence parameter that transfers the file from one storage area to another, would most likely be the result of an explicit instruction.

At state 502, where no file exists, transition action 517 “Create File”, with the persistence parameter on, causes a transfer to state 508, where a file is created and opened, and stored in the persistent storage area. A “Create File” action with the persistence parameter on would likely correspond to an explicit instruction to create the file in the persistent storage area 208. For example, to save data to a new file in the persistent storage area 208, the user would likely set a corresponding checkbox, such as described above in regard to FIG. 3B, explicitly indicating that the file is to be created in the persistent storage area. At state 508, transition action 519 “Close File”, with the persistence parameter is on, causes a transfer to state 510, where the file is closed and is stored in the persistent storage area 208. At state 510, transition action 521 “Set File Attribute”, with the persistence parameter is on, has no net effect because the file already exists in the persistent storage area.

At state 510, transition action 523 “Open File”, with the persistence parameter is on, causes a transfer to state 508, where the file is opened and stored in the persistent storage area 208. At state 508, transition action 525 “Set File Attribute”, with the persistence parameter is on, has no net effect because the file is already stored in the persistent storage area 208. At state 510, transition action 527 “Delete File” causes a transfer to state 502 where the file is deleted. At state 510, transition action 529 “Set File Attribute”, with the persistence parameter off, causes a transfer to state 506 where the file is closed and transferred to the non-persistent storage area 206. At state 508, with the file open and stored in persistent storage, transition action 531 “Close File”, with the persistence parameter set off, causes a transfer from state 508 to state 506 where the file is closed and stored in the non-persistent storage area 206. As described above, this “Close File” action is most likely related to an explicit instruction to store the file in the non-persistent storage area 206 because, by default, a file would be stored to its current storage area.

In order to effectuate the transitions between the states described above, the integration module 402 executes certain routines when a file system request is made on the integrated file system 400. By using these routines, including those described below, the integration module 402 ensures that the files corresponding to the file system requests are located within a correct storage area, makes adjustments as necessary, and then completes the file system requests.

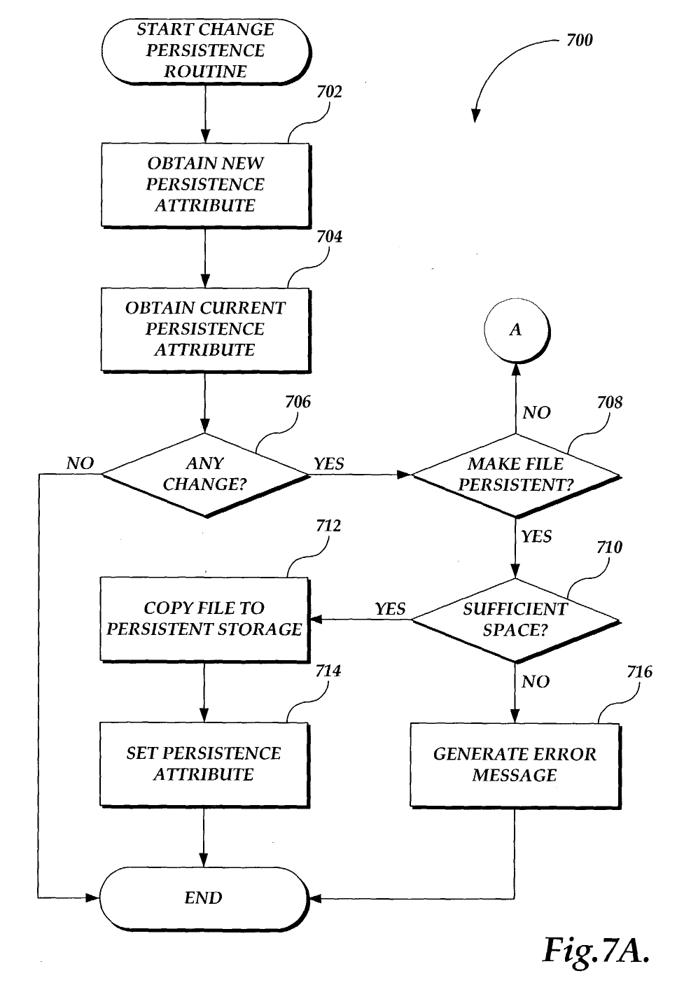

FIG. 6 is a flow diagram illustrative of a create file routine 600 for creating files in an integrated file system. Beginning at block 602, a file is created in the non-persistent storage area 206. According to one aspect of the present invention, the file is created first in non-persistent storage because of the persistent storage's inability to execute or access information in place. At decision block 604, a determination is made as to whether the file is to be stored in the persistent storage area 208. As previously described, this determination may be made by implicit file system actions or instructions, such as transferring a file from the non-persistent storage area 206 to the persistent storage area 208, or by explicit instructions, such as setting the persistence parameter to on. If the file is not to be stored in the persistent storage area 208, at block 606, a internal persistent storage attribute utilized by the integrated file system 400 and associated with the file is cleared. Thereafter, the routine terminates. It should be noted that the internal persistent storage attribute is a value utilized internally by the integrated file system 400 to identify its proper storage location, and does not correspond to the logical persistence parameter described above in regard to FIG. 5.

Alternatively, if, at decision block 604, the file is to be stored in the persistent storage area 208, at decision block 608, a further determination is made as to whether there is sufficient space in the persistent storage area 208 to store the file. If there is not sufficient space to store the file, at block 610, an error message is generated and presented to the user. Thereafter, at block 606, the internal persistent storage attribute associated with the file is cleared, and the routine terminates.

Alternatively, at decision block 608, if there is sufficient space to store the file in the persistent storage area 208, at block 612, the file is created in the persistent storage area. It should be noted that there may be now two copies of the file on the exemplary handheld computing device, one in the persistent storage area 208, and the other in the non-persistent storage area 206. However, the file in the non-persistent storage area is considered temporary and may later be deleted. At block 614, the persistent storage attribute associated with this file is set, internally indicating the file is persistent. Thereafter, the exemplary routine 600 terminates.

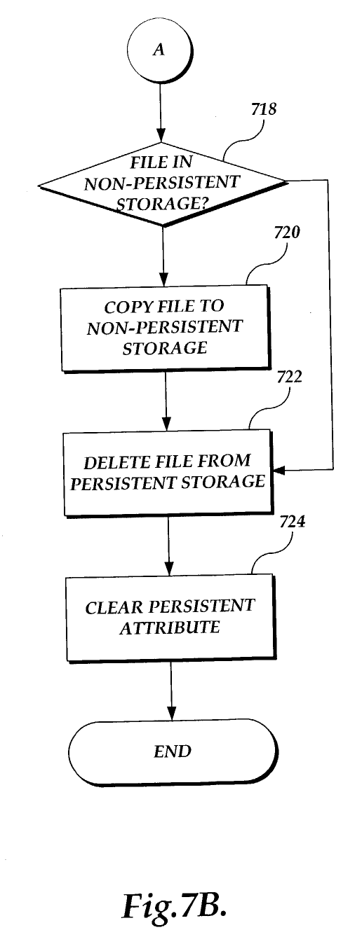

FIGS. 7A and 7B illustrate a change persistence attribute routine 700 for changing the persistence attribute of a file stored in an integrated file system 400, in accordance with the present invention. At block 702, a new value for the internal persistent storage attribute for a file is obtained. As previously discussed in regard to FIG. 3B, a user may alter the persistence of a file by changing the persistence box as shown in the file attributes box 318 (FIG. 3B). At block 704, the current value of the internal persistent storage attribute for the file is obtained. At decision block 706, a determination is made as to whether there is any change to the internal persistent storage attribute for the file. If, at decision block 706, no change is to be made, the exemplary routine 700 terminates. Alternatively, if the persistent storage attribute's current value and the new value are not the same, at decision block 708, a determination is made as to whether to make the file persistent, i.e., if the new value indicates the file is to be made persistent. If, at decision block 708, according to the new value, the file is to be placed in the persistent storage area 208, yet another determination is made at decision block 710, whether there is sufficient space in the persistent storage area to store the file. If there is sufficient space in the persistent storage area 208, a copy of the file is created in the persistent storage area 208 at block 712. At block 714, the persistent storage attribute associated with the file is set, indicating the file's storage in the persistent storage area 208.

Alternatively, if it is determined at decision block 710 that there is not sufficient space in the persistent storage area 208 for the file, an error is generated at a block 716 indicating that the change persistence routine cannot be completed. Thereafter the routine terminates.

Returning to decision block 708, if the new value indicates the file is to be stored in the non-persistent storage area, it may be necessary to transfer the file to the non-persistent storage area. Accordingly, at decision block 718 (FIG. 7B), it is determined whether a copy of the file already exists in the non-persistent storage area 206. As previously discussed, multiple copies of the same file may simultaneously exist, due to the inability to access files stored in the persistent storage area 208 in an access-in-place manner. If a copy of the file does not already exist in the non-persistent storage area 206, the file is copied to the non-persistent storage area at block 720. After a copy has either been found or placed in the non-persistent storage area 206, the copy of the file in the persistent storage area is deleted at block 722. Accordingly, the internal persistent storage attribute associated with the file is cleared at block 724. Thereafter, the routine 700 terminates.

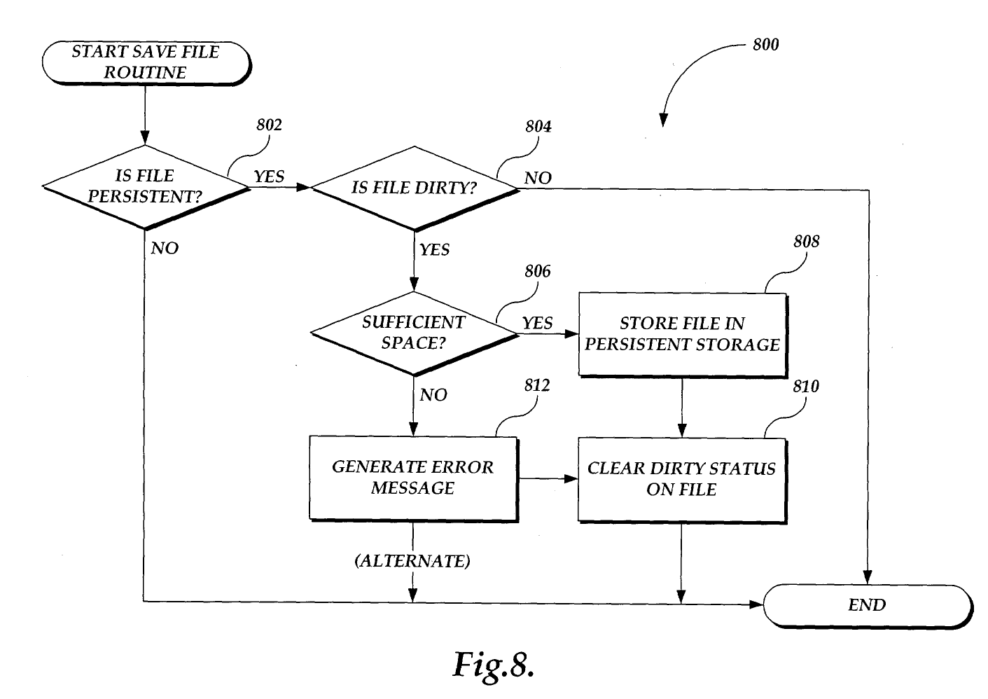

FIG. 8 is a flow diagram illustrating a save file routine 800 for saving files in an integrated file system 400 formed in accordance with the present invention. Beginning at decision block 802, a determination is made as to whether the file is persistent. This determination is made according to the internal persistence value associated with the file as described above. If the file is persistent, i.e., a copy of the file is stored in the persistent storage area 208, another determination is made as to whether the file is dirty at decision block 804. For purposes of the present discussion, a file is dirty when a copy of the file in the non-persistent storage area 206 has been modified or changed from that copy which is stored in the persistent storage area 208.

If the non-persistent copy of the file is dirty, i.e., has been modified, a further determination is made at decision block 806 as to whether there is sufficient storage space in the persistent storage area 208 to accommodate the file. If there is sufficient space to accommodate the modifications made to the file, the file is copied to the persistent storage area at block 808. Those skilled in the art will appreciate that this step involves deleting the previous version of the file and replacing it with the new, updated version. At block 810, the dirty status of the file is cleared. According to aspects of the present invention, when a copy of a file in the non-persistent storage area 206 has been modified by an application or by user interaction, and the file is also a copy of a file in the persistent storage area 208, an attribute associated with the file is set indicating that the file is dirty. Therefore, clearing the dirty status of a file involves clearing the dirty attribute associated with that file. After clearing the dirty status of the file, the routine 800 terminates.

Returning to decision block 806, if there is insufficient space to accommodate the updated file, an error message is generated at block 812. At block 810, the dirty status of the file is cleared, and the routine 800 terminates. Alternatively, after generating the error message the routine could simply terminate, preserving the dirty status so that the user may free space within the persistent storage area 208 and again attempt to save the file in the persistent storage.

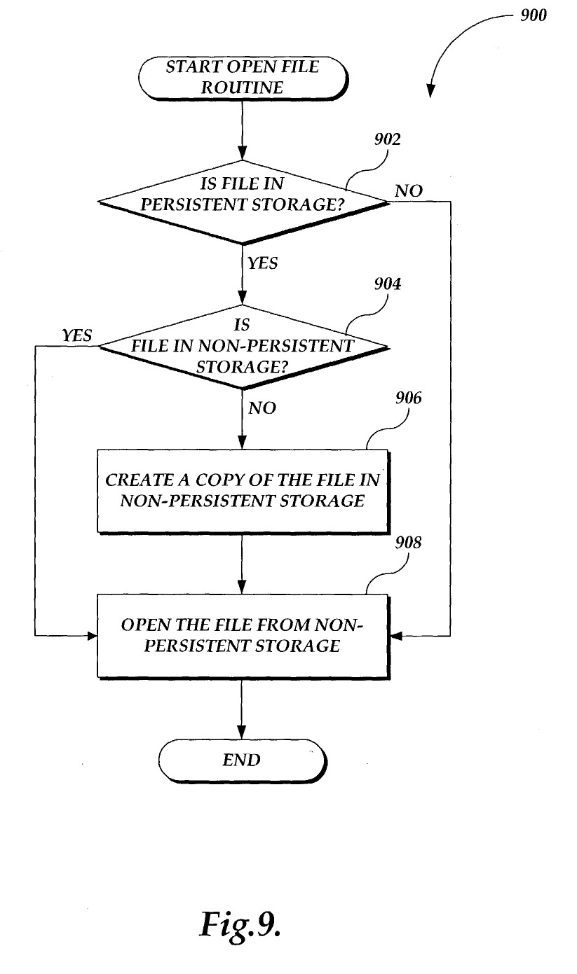

FIG. 9 is a flow diagram illustrating an open file routine 900 for opening files in an integrated file system formed in accordance with the present invention. At decision block 902, it is determined whether the file to be opened is currently in the persistent storage area 208. If the file is not currently in the persistent storage area 208, this means that the file is in the non-persistent storage area 206. Therefore, if the file is not in the persistent storage area 208, at block 908, the file is opened from the non-persistent storage area 206. Thereafter, the routine 900 terminates.

However, if the file is in the persistent storage area 208, a further determination is made at decision block 904 as to whether a copy of the file exists in the non-persistent storage area 206. If a copy of the file exists in the non-persistent storage area 206, the file is opened from non-persistent storage at block 908, and the routine 900 terminates. However, if the file does not exist in the non-persistent storage area 206, a copy of the file is created in the non-persistent storage area at block 906, the file is opened in block 908 from the non-persistent storage area, and the routine 900 terminates.

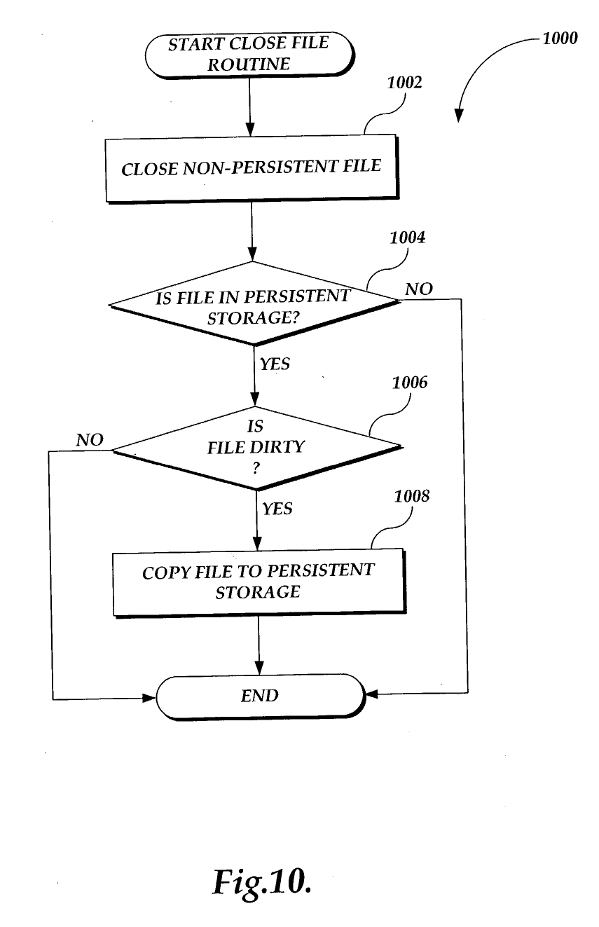

FIG. 10 is a flow diagram illustrating a close file routine 1000 for closing files in an integrated file system. As previously discussed, because the persistent storage area 208 is not an execute- or access-in-place storage area, operating on a file stored in the persistent storage area requires the system to copy the file to the non-persistent storage area and perform the operation on the copy. Thus, when closing a file, at least a copy of the file will exist in the non-persistent storage area 206. Accordingly, at block 1002, the copy of the file in the non-persistent storage area 206 is closed.

At decision block 1004, it is determined whether the file currently is stored in the persistent storage area 208. If the file is not stored in the persistent storage area 208, the routine 1000 terminates. However, if the file is stored in the persistent storage area 208, another determination is made, at decision block 1006, as to whether the file is dirty. As previously discussed, a file is dirty when the copy in the non-persistent storage area 206 differs from the version of the file stored in the persistent storage area 208. If the file is dirty, at block 1008, the copy of the file in the non-persistent storage area 206 is copied to the persistent storage area 208. Thereafter, the routine 1000 terminates.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. An integrated file system on a handheld computing device for managing files stored in persistent and non-persistent storage areas for an operating system, the system comprising:
(a) a persistent storage area;
(b) a non-persistent storage area; and
(c) an integration module communicatively coupled to the persistent and non-persistent storage areas, and further communicatively coupled to the operating system, wherein the integration module presents the persistent and non-persistent storage areas as an integrated storage area to the operating system.

2. The system of claim 1, wherein the integration module presents the integrated storage area to the operating system as a non-persistent storage area.

3. The system of claim 1, wherein the integration module presents the files stored in the integrated storage area as files available for direct access by the operating system.

4. The system of claim 3, wherein the integration module presents the files stored in the integrated storage area as files available for direct access by the operating system by:
upon receiving an access request for a file stored in the integrated storage area,
determining whether a copy of the file exists in the non-persistent storage area, and if not, creating a copy of the file in the non-persistent storage area from a copy of the file in the persistent storage area; and
completing the access request on the copy of the file in the non-persistent storage area.

5. The system of claim 4, wherein the integration module further presents the files stored in the integrated storage area as files available for direct access by the operating system by:
upon receiving a storage request to store data to a file stored in the integrated storage area,
storing the data in a copy of the file in the non-persistent storage area; and
determining if a copy of the file exists in the persistent storage area, and if so, copying the data in the copy of the file in the non-persistent storage area to the copy of the file in the persistent storage area.

6. The system of claim 5, wherein the integration module further presents the files stored in the integrated storage area as files available for direct access by the operating system by:
upon receiving an open file request to open a file stored in the integrated storage area,
determining if a copy of the file exists in the non-persistent storage area, and if not, copying the file from the persistent storage area to the non-persistent storage area; and
opening the copy of the file in the non-persistent storage area.

7. The system of claim 6, wherein the integration module further presents the files stored in the integrated storage area as files available for direct access by the operating system by:
upon receiving a close file request to close a file stored in the integrated storage area,
determining whether a copy of the file exists in the persistent storage area, and if so, further determining whether the file in the non-persistent storage area is different from the copy of the file in the persistent storage area, and if so, copying the file from the non-persistent storage area to the persistent storage area; and
closing the file in the non-persistent storage area.

8. The system of claim 1, wherein the integration module presents the persistent and non-persistent storage areas as an integrated storage area to the operating system by:
providing a persistence attribute associated with each file stored in the integrated storage area, the persistence attribute having either a persistent state or non-persistent state value.

9. The system of claim 8, wherein the integration module further presents the persistent and non-persistent storage areas as an integrated storage area to the operating system by:
upon receiving a persistence attribute change request to change the persistence attribute value associated with a file stored in the integrated file system from non-persistent state to persistent state,
creating a copy of the file in the persistent storage area from the file stored in the non-persistent storage area; and
changing the persistence attribute value to persistent state.

10. The system of claim 9, wherein the integration module further presents the persistent and non-persistent storage areas as an integrated storage area to the operating system by:
upon receiving a persistence attribute change request to change the persistence attribute value associated with a file stored in the integrated file system from non-persistent state to persistent state and after creating a copy of the file in the persistent storage area from the file stored in the non-persistent storage area,
deleting the copy of the file in the non-persistent storage area.

11. The system of claim 9, wherein the integration module further presents the persistent and non-persistent storage areas as an integrated storage area to the operating system by:
upon receiving a persistence attribute change request to change the persistence attribute value associated with a file stored in the integrated file system from persistent state to non-persistent state,
determining whether a copy of the file exists in the non-persistent storage area, and if not, copying the file to the non-persistent storage area from the persistent storage area;
changing the persistence attribute value to non-persistent state; and
deleting the copy of the file in the persistent storage area.

12. A method for implementing file system requests on a handheld computing device by an integrated file system that presents files stored in persistent and non-persistent storage areas as files in an integrated storage area, comprising:
(a) receiving a file system request relating to a file stored in the integrated file system;
(b) determining whether the file is currently stored in an area of the integrated file system such that the file system request may be completed, and if not, copying the file to the area in the integrated file system such that the file system request may be completed; and
(c) completing the file system request on the file.

13. The method of claim 12, wherein the file system request is an execute program file request;
wherein determining whether the file is currently stored in an area of the integrated file system such that the file system request may be completed, and if not, copying the file to the area in the integrated file system such that the file system request may be completed comprises determining whether a non-persistent copy of the file currently exists in the non-persistent storage area, and if not, creating a non-persistent copy of the file in the non-persistent storage area from a copy of the file in the persistent storage area; and
wherein completing the file system request on the file comprises executing the non-persistent copy of the file stored in the non-persistent storage area in accordance with the execute program file request.

14. The method of claim 12, wherein the file system request is read file request;
wherein determining whether the file is currently stored in an area of the integrated file system such that the file system request may be completed, and if not, copying the file to the area in the integrated file system such that the file system request may be completed comprises determining whether a non-persistent copy of the file currently exists in the non-persistent storage area, and if not, creating a non-persistent copy of the file in the non-persistent storage area from a persistent copy of the file in the persistent storage area; and
wherein completing the file system request on the file comprises reading the non-persistent copy of the file in the non-persistent storage area in accordance with the read file request.

15. The method of claim 12, wherein the file system request is an save file request;
wherein determining whether the file is currently stored in an area of the integrated file system such that the file system request may be completed, and if not, copying the file to the area in the integrated file system such that the file system request may be completed comprises determining whether the file is to be stored in persistent storage; and
wherein completing the file system request on the file comprises:
saving a non-persistent copy of the file in the non-persistent storage area; and
if, in accordance with the previous determination, the file is to be stored in the persistent storage area, creating a persistent copy of file in the persistent storage area from the non-persistent copy of the file in the non-persistent storage area in accordance with the save file request.

16. The method of claim 12, wherein the file system request is a close file request;
wherein determining whether the file is currently stored in an area of the integrated file system such that the file system request may be completed, and if not, copying the file to the area in the integrated file system such that the file system request may be completed comprises determining whether the file is to be stored in persistent storage; and
wherein completing the file system request on the file comprises:
closing a non-persistent copy of the file in the non-persistent storage area; and
if, in accordance with the previous determination, the file is to be stored in the persistent storage area, creating a persistent copy of file in the persistent storage area from the non-persistent copy of the file in the non-persistent storage area in accordance with the save file request.

17. The method of claim 12, wherein the file system request is a make persistent request;
wherein determining whether the file is currently stored in an area of the integrated file system such that the file system request may be completed, and if not, copying the file to the area in the integrated file system such that the file system request may be completed comprises determining whether the file is not already stored in persistent storage; and
wherein completing the file system request on the file comprises:
if, in accordance with the previous determination, the file is not already stored in the persistent storage area, creating a persistent copy of file in the persistent storage area from a non-persistent copy of the file in the non-persistent storage area.

18. The method of claim 17, wherein completing the file system request on the file further comprises:
if, in accordance with the previous determination, the file was not already stored in the persistent storage area, deleting the non-persistent copy of the file in the non-persistent storage area.

19. The method of claim 12, wherein the file system request is a make non-persistent request;
wherein determining whether the file is currently stored in an area of the integrated file system such that the file system request may be completed, and if not, copying the file to the area in the integrated file system such that the file system request may be completed comprises determining whether the file is already stored in the non-persistent storage; and
wherein completing the file system request on the file comprises:
if, in accordance with the previous determination, the file is not stored in the non-persistent storage area:
creating a non-persistent copy of the file in the non-persistent storage area from a persistent copy of the file in the persistent storage area; and
deleting the persistent copy of the file in the persistent storage area.

20. A computer-readable medium having computer-readable instructions which, when executed, carry out a method for implementing file system requests on a handheld computing device by an integrated file system that presents files stored in persistent and non-persistent storage areas as files in an integrated storage area, comprising:
(a) receiving a file system request relating to a file stored in the integrated file system;
(b) determining whether the file is currently stored in an area of the integrated file system such that the file system request may be completed, and if not, copying the file to the area in the integrated file system such that the file system request may be completed; and
(c) completing the file system request on the file.

21. The computer-readable medium of claim 20, wherein the file system request is an execute program file request;
wherein determining whether the file is currently stored in an area of the integrated file system such that the file system request may be completed, and if not, copying the file to the area in the integrated file system such that the file system request may be completed comprises determining whether a non-persistent copy of the file currently exists in the non-persistent storage area, and if not, creating a non-persistent copy of the file in the non-persistent storage area from a copy of the file in the persistent storage area; and
wherein completing the file system request on the file comprises executing the non-persistent copy of the file stored in the non-persistent storage area in accordance with the execute program file request.

22. The computer-readable medium of claim 20, wherein the file system request is read file request;
wherein determining whether the file is currently stored in an area of the integrated file system such that the file system request may be completed, and if not, copying the file to the area in the integrated file system such that the file system request may be completed comprises determining whether a non-persistent copy of the file currently exists in the non-persistent storage area, and if not, creating a non-persistent copy of the file in the non-persistent storage area from a persistent copy of the file in the persistent storage area; and
wherein completing the file system request on the file comprises reading the non-persistent copy of the file in the non-persistent storage area in accordance with the read file request.

23. The computer-readable medium of claim 20, wherein the file system request is an save file request;
wherein determining whether the file is currently stored in an area of the integrated file system such that the file system request may be completed, and if not, copying the file to the area in the integrated file system such that the file system request may be completed comprises determining whether the file is to be stored in persistent storage; and
wherein completing the file system request on the file comprises:
saving a non-persistent copy of the file in the non-persistent storage area; and
if, in accordance with the previous determination, the file is to be stored in the persistent storage area, creating a persistent copy of file in the persistent storage area from the non-persistent copy of the file in the non-persistent storage area in accordance with the save file request.

24. The computer-readable medium of claim 20, wherein the file system request is a close file request;
wherein determining whether the file is currently stored in an area of the integrated file system such that the file system request may be completed, and if not, copying the file to the area in the integrated file system such that the file system request may be completed comprises determining whether the file is to be stored in persistent storage; and
wherein completing the file system request on the file comprises:
closing a non-persistent copy of the file in the non-persistent storage area; and
if, in accordance with the previous determination, the file is to be stored in the persistent storage area, creating a persistent copy of file in the persistent storage area from the non-persistent copy of the file in the non-persistent storage area in accordance with the save file request.

25. The computer-readable medium of claim 20, wherein the file system request is a make persistent request;
wherein determining whether the file is currently stored in an area of the integrated file system such that the file system request may be completed, and if not, copying the file to the area in the integrated file system such that the file system request may be completed comprises determining whether the file is not already stored in persistent storage; and
wherein completing the file system request on the file comprises:
if, in accordance with the previous determination, the file is not already stored in the persistent storage area, creating a persistent copy of file in the persistent storage area from a non-persistent copy of the file in the non-persistent storage area.

26. The computer-readable medium of claim 25, wherein completing the file system request on the file further comprises:
if, in accordance with the previous determination, the file was not already stored in the persistent storage area, deleting the non-persistent copy of the file in the non-persistent storage area.

27. The computer-readable medium of claim 20, wherein the file system request is a make non-persistent request;
wherein determining whether the file is currently stored in an area of the integrated file system such that the file system request may be completed, and if not, copying the file to the area in the integrated file system such that the file system request may be completed comprises determining whether the file is already stored in the non-persistent storage; and
wherein completing the file system request on the file comprises:
if, in accordance with the previous determination, the file is not stored in the non-persistent storage area:
creating a non-persistent copy of the file in the non-persistent storage area from a persistent copy of the file in the persistent storage area; and
deleting the persistent copy of the file in the persistent storage area.
